(19) United States
(12) Patent Application Publication
(10) Pub. No.: US 2017/0131112 A1
(43) Pub. Date: May 11, 2017

(54) INFORMATION PROCESSING DEVICE, PROCESSING METHOD AND RECORDING MEDIUM STORING PROGRAM THEREOF

(71) Applicant: NEC Corporation, Tokyo (JP)

(72) Inventors: Masatsugu OGAWA, Tokyo (JP); Hisaya WAKAYAMA, Tokyo (JP); Norihisa IGA, Tokyo (JP)

(73) Assignee: NEC Corporation, Tokyo (JP)

(21) Appl. No.: 15/318,056

(22) PCT Filed: Jun. 24, 2015
(86) PCT No.: PCT/JP2015/003149

§ 371 Date: Dec. 12, 2016

(30) Foreign Application Priority Data
Jun. 25, 2014 (JP) 2014-130629

(51) Int. Cl. G01C 21/36; G06Q 50/30

(52) U.S. Cl. CPC G01C 21/3667; G06Q 50/30

(57) ABSTRACT

An information processing device includes: an information collection unit that collects first position information representing a position of a first moving object and second position information representing a position at which a second moving object takes on a transport target; a location information generation unit that generates location information of the first moving object, based on the first position information; a map information generation unit that generates a surrounding area map of the first moving object, based on the location information; a frequency information generation unit that, based on the surrounding area map and the second position information, generates frequency information representing the number of times that the second moving object takes on the transport target per unit time in any region of the surrounding area map; and an information display unit controls displaying of the surrounding area map and the frequency information.

### TECHNICAL FIELD

The present disclosure relates to allocation of resources to people or objects that are spatially distributed.

### BACKGROUND ART

There are needs for efficiently allocating (matching) limited resources to people or objects that are spatially distributed. This kind of needs are, for example, allocating an empty taxi to a taxi user, a delivery truck to an object to be delivered to a convenience store or a home, and a car to an empty parking lot. These can be considered to certain kinds of matching problem between demand and supply.

As one of methods for solving such a problem, there is known a method which predicts a demand occurrence by acquiring an enormous amount of data, and accordingly makes a supply plan in advance to cope with the demand. By use of this method, locations of passengers waiting for taxis are predicted and, according to the prediction, taxi allocation control is performed.

Patent Literature 1 (PTL 1) describes a system, for making an operation plan of a facility for sharing resources, such as a datacenter, predicts future demand of not only the existing users but also new users, and, for predicted demand, efficiently provides the facility's infrastructure equipment and virtual environment.

Patent Literature 2 (PTL 2) describes displaying, based on data on predicted demand for vehicle allocation, the magnitude of the predicted demand for vehicle allocation, along with location information of other vehicles, using a mark. Further, Patent Literature 3 (PTL 3) describes an example in which prediction of taxi demand is adjusted in response to occurrence of a railway accident.

However, such prediction methods easily permit failure of demand prediction due to occurrence of an unexpected event such as a train accident and a natural disaster.

Currently, such an unexpected sudden increase or decrease in demand as described above is coped with by humans. In the taxi allocation case, an order for allocating a taxi is manually sent to the driver from the taxi company by wireless. However, it is difficult for a taxi company operating as many as about 1000 taxis to perform optimum matching of the taxis by human resources. It is applied to the case for not only the taxi allocation but also collection and delivery of delivery objects, and also matching between cars and parking lots.

### CITATION LIST

### Patent Literature

### [PTL 1] Japanese Laid-Open Patent Application No. 2014-006756

### [PTL 2] Japanese Laid-Open Patent Application No. 2008-065396

### [PTL 3] Japanese Laid-Open Patent Application No. 2008-052455

### SUMMARY OF INVENTION

### Technical Problem

To perform matching between supply and demand in response to an unexpected demand change, it is necessary to immediately grasp the demand change and reflect it in supply, and accordingly, there is a need for an information processing device capable of presenting the demand level to the supply side.

An objective of the present invention is to provide an information processing device for solving the above-described problem.

### Solution to Problem

An information processing device according to one aspect of the present invention includes:
an information collection unit that collects first position information representing a position of a first moving object and second position information representing a position at which a second moving object takes on a transport target;
a location information generation unit that generates location information of the first moving object, based on the first position information;
a map information generation unit that generates a surrounding area map of the first moving object, based on the location information;
a frequency information generation unit that, based on the surrounding area map and the second position information, generates frequency information representing the number of times that the second moving object takes on the transport target per unit time in any region of the surrounding area map; and
an information display unit controls displaying of the surrounding area map and the frequency information.

A processing method according to the present invention includes:
collecting first position information representing a position of a first moving object and second position information representing a position at which a second moving object takes on a transport target;
generating location information of the first moving object, based on the first position information;
generating a surrounding area map of the first moving object, based on the location information;
based on the surrounding area map and the second position information, generating frequency information representing number of times that the second moving object takes on the transport target per unit time in any region of the surrounding area map; and
controlling displaying of the surrounding area map and the frequency information.

A recording medium storing a program for causing a computer to execute:
collecting first position information representing a position of a first moving object and second position information representing a position at which a second moving object takes on a transport target;
generating location information of the first moving object, based on the first position information;
generating a surrounding area map of the first moving object, based on the location information;
based on the surrounding area map and the second position information, generating frequency information representing number of times that the second moving object takes on the transport target per unit time in any region of the surrounding area map; and controlling displaying of the surrounding area map and the frequency information.

### Advantageous Effects of Invention

According to the present invention, it is possible, in response to demand that changes unexpectedly, to present the demand level to the supply side. As a result, it becomes possible to match the supply to the changing demand.

### BRIEF DESCRIPTION OF DRAWINGS

FIG. 1 is a diagram illustrating a configuration of an information processing device according to a first example embodiment

FIG. 2 is a schematic diagram illustrating a surrounding area map with frequency information according to the information processing device of the first example embodiment

FIG. 3 is a flow chart illustrating operation of the information processing device of the first example embodiment

FIG. 4 is a diagram illustrating a configuration of an information processing device according to a second example embodiment

FIG. 5 is a schematic diagram illustrating a surrounding area map with frequency information of road regions, according to the information processing device of the second example embodiment

FIG. 6 is a diagram illustrating a configuration of an information processing device according to a third example embodiment

FIG. 7 is a schematic diagram illustrating a surrounding area map with frequency information, according to the information processing device of the third example embodiment

FIG. 8 is a schematic diagram illustrating a surrounding area map with frequency information, according to the information processing device of the third example embodiment

FIG. 9 is a diagram illustrating a configuration of an information processing device according to a fourth example embodiment

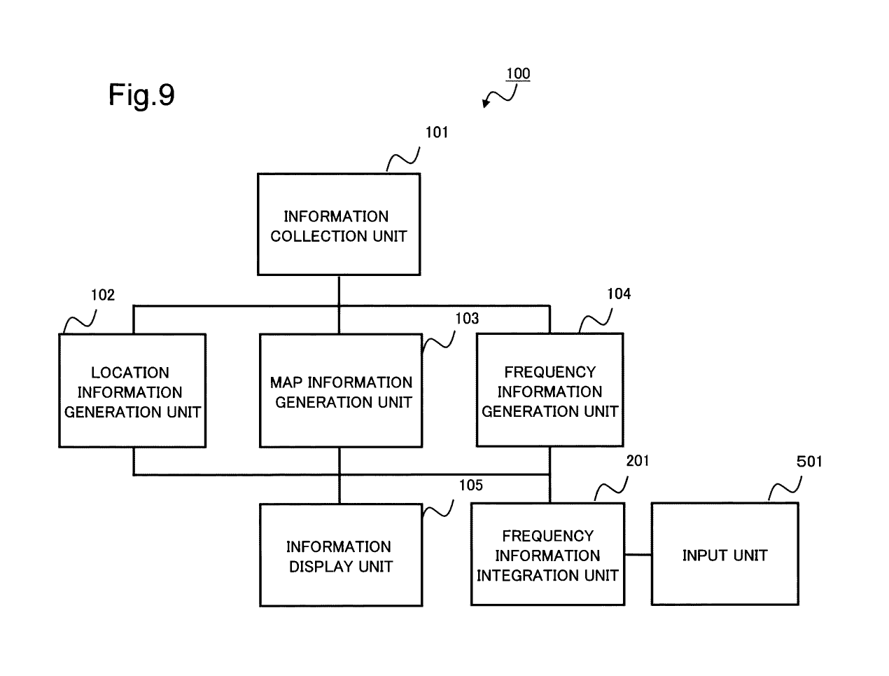

FIG. 10 is a diagram illustrating a hardware configuration of the information processing devices in the first to fourth example embodiments

### DESCRIPTION OF EMBODIMENTS

An information processing device according to one aspect of the present invention includes: an information collection unit that collects first position information representing the position of a first moving object and second position information representing positions at which second moving objects take on transport targets; and a location information generation unit that generates location information of the first moving object, based on the first position information. The information processing device further includes: a map information generation unit that generates a surrounding area map of the first moving object, based on the location information; and a frequency information generation unit that, based on the surrounding area map and the second position information, generates frequency information representing the number of times that the second moving objects take on transport targets per unit time in any region of the surrounding area map. The information processing device further includes an information display unit that controls displaying of the surrounding area map and the frequency information.

According to the information processing device having the above-described aspect, it is possible, in response to demand that changes unexpectedly, to present the demand level to the supply side. It is because the information collection unit collects the second position information representing positions at which the second moving objects take on transport targets and, based on the second position information, and the frequency information generation unit generates the frequency information representing the number of times that the second moving objects take on transport targets, thereby making it possible to perform information display, at the first moving object, of the frequency information representing a level of transport targets' demand calculated per predetermined unit time.

Example embodiments of the present invention will be described in detail, with reference to drawings. Hereinafter, the example embodiments will be described an example in which an information processing device according to the present invention is applied to match taxi users and taxis.

### (First Example Embodiment

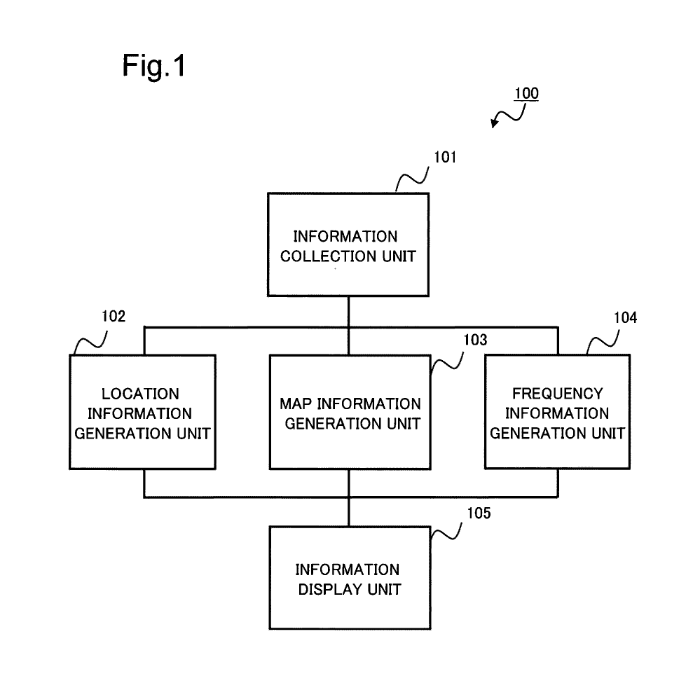

FIG. 1 is a schematic diagram illustrating a configuration of an information processing device according to a first example embodiment. The information processing device 100 includes an information collection unit 101, a location information generation unit 102, a map information generation unit 103, a frequency information generation unit 104 and an information display unit 105.

The information collection unit 101 collects first position information representing the position of a first moving object and second position information representing positions at which second moving objects take on transport targets. Specifically, the moving objects are taxis, and the transport targets are taxi users. Here, the first moving object is an empty taxi, and the second moving objects are taxis with passengers on board. The first position information is Global Positioning System (GPS) information indicating the position of the empty taxi, and the second position information is GPS information indicating positions at which taxis take on passengers. For the position information for each of the moving objects, for example, GPS information held by a car navigation device with GPS function or a wireless terminal with GPS function, which is installed in a taxi, may be used. The position information representing a position at which a taxi takes on a passenger may be acquired at the taxi side, using start and payment information held by the taximeter and GPS information of the taxi. An example of GPS information is latitude and longitude information.

In that way, the GPS information indicating the position of an empty taxi or that indicating a position at which a taxi takes on a passenger is sent from each taxi to the information processing device 100 via a communication device, in accordance with update of information for passengers' getting on and off the taxi.

Alternatively, there may be a plurality of the first moving objects and a plurality of the second moving objects. Along with the first or second position information, each of the moving objects may send an ID (Identification) for identifying the moving object (taxi) or information for getting on or off of transport targets (passengers).

The information collection unit 101 passes the first and second position information it has collected, respectively, to the location information generation unit 102 and to the frequency information generation unit 104.

Then, based on the first position information, the location information generation unit 102 generates location information of the first moving object. That is, location information of an empty taxi is generated based on GPS information of the empty taxi. The location information is, for example, information representing a place on a map.

The map information generation unit 103 has a map information database (not illustrated) and, based on the location information of the first moving object generated by the location information generation unit 102, generates a surrounding area map of the location of the first moving object. That is, it generates a surrounding area map of the location of an empty taxi. Here, the map information database may be provided in the map information generation unit 103, or may be provided inside or outside the information processing device 100.

Based on the surrounding area map thus generated and the second position information thus collected, the frequency information generation unit 104 generates frequency information representing the number of times that the second moving objects take on the transport targets per unit time in an arbitrary region of the surrounding area map. Specifically, the number of taxis that has changed from being empty to being occupied per unit time is calculated for each divided region of the surrounding area map of a certain empty taxi, and the calculation result is determined to be the frequency information.

A single unit of the divided regions is assumed to be a square of 100 m by 100 m here, for example, but it may be 50 m by 50 m, or may have another shape than square. It is not necessarily required to divide the whole surrounding area map into regions, but it is enough that at least areas having a road are divided into regions. The unit time used in calculating the frequency is assumed to be 10 minutes here, for example, but a different unit time may alternatively be used. It is preferable to determine the unit time so as to be adaptable to the amount of change in the frequency.

The information display unit 105 controls displaying of the surrounding area map and the frequency information. For example, the information display unit 105 controls a display device (not illustrated) to display the surrounding area map with the frequency information superposed on it. These pieces of information are provided for an information viewer operating the first moving object (the driver of an empty taxi). The control of displaying the frequency information includes, for example, directly displaying a number expressing the frequency information in a manner to superpose it on the surrounding area map, displaying the frequency information with a color or an icon correlated with a value represented by the frequency information, or the like. Further, the information display unit 105 may display information generated by the location information generation unit 102 (for example, latitude and longitude information), as supplementary information.

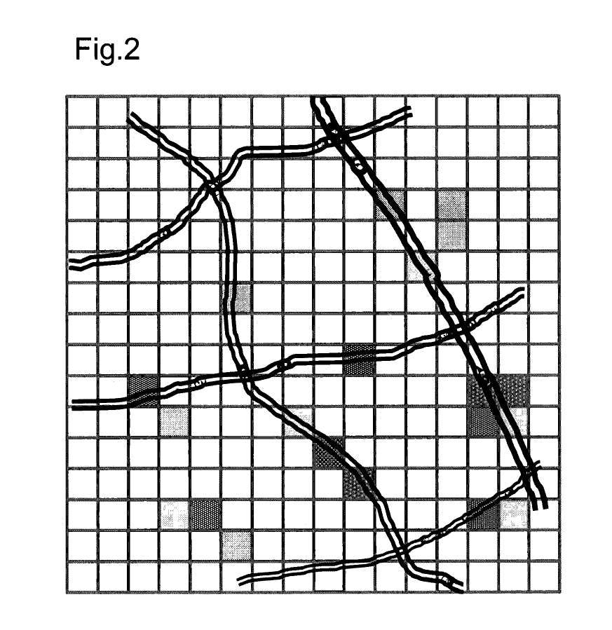

FIG. 2 is a schematic diagram illustrating a surrounding area map and frequency information controlled by the information display unit of the first example embodiment. In FIG. 2, main roads are displayed while setting the center of the surrounding area map to be the location of an empty taxi, which is the first moving object. In the first example embodiment, the frequency information for each of divided regions is expressed by a tone of a grid segment. In FIG. 2, each grid segment is displayed in a lighter tone for frequency information representing a smaller value, and in a darker tone for frequency information representing a larger value. It indicates that a larger number of passengers are waiting for taxis in a region where the grid segment is displayed in a darker tone.

The driver of an empty taxi checks the roads and frequency information on the surrounding area map and accordingly moves toward a region where a large number of passengers are waiting for taxis, and as a result, thereby making it possible to match demand and supply.

While frequency information displayed on the surrounding area map is expressed, in the above example, by the tone of the grid segment, a color correlated with the value represented by the frequency information may alternatively be displayed. For example, in FIG. 2, frequency information may be transformed such that each grid segment is displayed in a color closer to blue color for frequency information representing a smaller value, and in a color closer to red color for frequency information representing a larger value. When thus displaying with a color correlated with a value represented by the frequency information, it is desirable to make the superposition using a translucent color so that the surrounding area map displayed underneath is not obscured by the color expressing the frequency information.

Further, when displaying frequency information in the form of an icon, for example, human-shaped icons may be displayed with their total number being varied according to a value represented by the frequency information, or a human-shaped icon may be displayed with its size varied according to the value represented by the frequency information. Here, the range of an area displayed in the surrounding area map can be arbitrary changed (zoom in or zoom out).

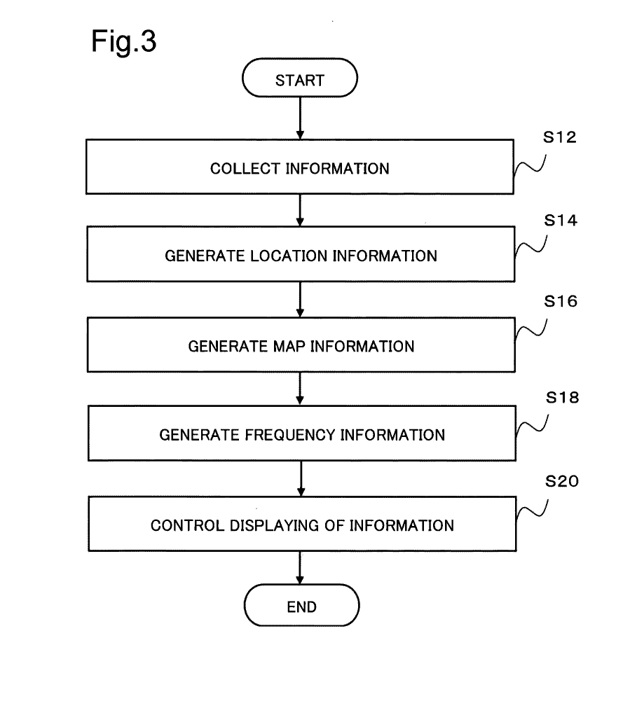

Next, operation of the information processing device according to the first example embodiment will be described, using FIGS. 1 and 3. FIG. 3 is a flow chart illustrating the operation of the information processing device.

The information collection unit 101 of the information processing device 100 collects first position information representing the position of a first moving object and second position information representing positions at which second moving objects take on transport targets (S12). That is, the information collection unit 101 collects GPS information indicating the position of an empty taxi and GPS information indicating positions at which taxis take on passengers. Alternatively, there may be a plurality of the first moving objects and a plurality of the second moving objects.

Then, based on the first position information, the location information generation unit 102 of the information processing device 100 generates location information of the first moving object (S14). That is, the location information generation unit 102 generates location information of an empty taxi, based on GPS information of the empty taxi.

Then, based on the location information, the map information generation unit 103 of the information processing device 100 generates a surrounding area map of the first moving object (S16). That is, the map information generation unit 103 generates a surrounding area map of the location of the empty taxi, using a map information database.

Subsequently, based on the surrounding area map and the second position information, the frequency information generation unit 104 of the information processing device 100 generates frequency information representing the number of times that the second moving objects takes on the transport targets per unit time in an arbitrary region of the surrounding area map (S18). The frequency information generation unit 104 divides the surrounding area map of the empty taxi into arbitrary regions and, for each of the divided regions, calculates a ride frequency representing that the number of times that taxis take on passengers per unit time in the region. For example, the ride frequency is calculated as the number of locations included within one of the divided regions in the surrounding area map at which passengers got on taxis during ten minute period. Accordingly, it becomes possible to provide instantaneous frequency information.

Then, the information display unit 105 of the information processing device 100 controls displaying of the surrounding area map and the frequency information (S20). For example, the information display unit 105 displays frequency information representing frequency of passengers' getting on taxis in a manner of superposing it on the surrounding area map of an empty taxi, and accordingly, the driver of the empty taxi recognizes a level of demand for taxi use in the surrounding area. As a result, it becomes possible to provide an empty taxi for a region whose frequency information represents a large value.

According to the information processing device of the first example embodiment, it is possible, in response to demand that changes unexpectedly, to present a level of the demand to the supply side. For example, even when the number of passengers waiting for a taxi changes unexpectedly, it is possible to inform the driver of an empty taxi in the form of frequency information. It is because the frequency information is not information based on demand prediction but is information representing a level of the demand calculated per predetermined unit time. That is, the boarding frequency of taxi users provided for the taxi driver is information reflecting the users' boarding state which has changed unexpectedly.

The taxi driver who is a viewer of the information checks the users' boarding frequency on the surrounding area map of the taxi location, and accordingly moves the taxi toward a region having a higher value of the users' boarding frequency on the surrounding area map. As a result, imbalance between increase in the number of taxi users and lack of taxis is resolved.

### Second Example Embodiment

A taxi may take on a passenger on a road, besides at a designated taxi stand. Therefore, if the frequency information is displayed for each road, a taxi driver can determine on which road a passenger can be found most efficiently. Further, if the frequency information is displayed for a broader region, a taxi driver can obtain a broader perspective about regions where the number of passengers waiting for taxis is changing, thereby helping a taxi driver to determine a direction to which the taxi is to be moved. An information processing device of a second example embodiment is an example of meeting such needs.

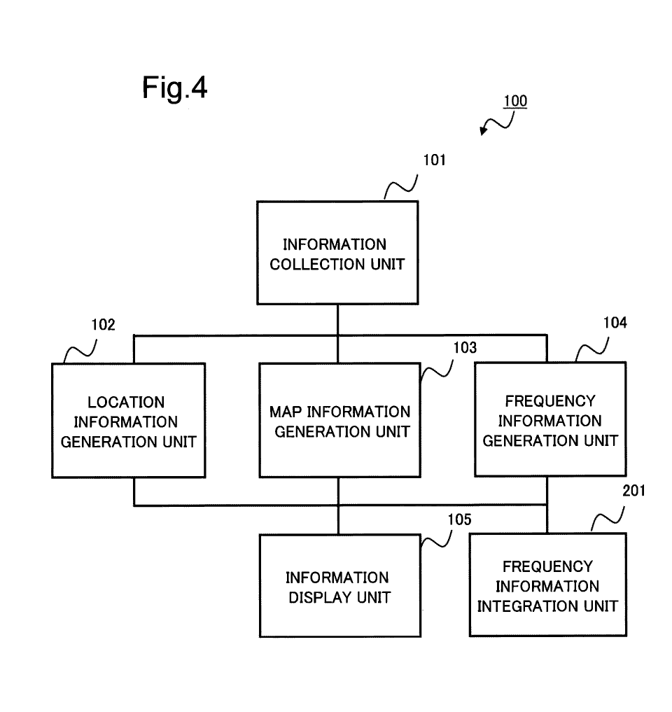

The second example embodiment will be described in detail, using drawings. FIG. 4 is a diagram illustrating a configuration of the information processing device according to the second example embodiment. The information processing device of the second example embodiment is obtained by adding a frequency information integration unit 201 to the information processing device 100 of the first example embodiment.

The frequency information integration unit 201 of FIG. 4 integrates pieces of frequency information of respective regions generated by the frequency information generation unit 104, per unit road region constituted by roads within a surrounding area map or per unit wide region constituted by a plurality of regions. For each road region, integration of frequency information is performed on regions each including a predetermined road, among regions into which the surrounding area map is divided.

The frequency information integration unit 201 sends also region information regarding regions constituting the road region or the wide region (region information), to the information display unit 105. The region information is identification information of the regions. For example, it may be a region code which is assigned to each of regions when dividing the surrounding area map into them. In this case, the region information becomes a set of a plurality of region codes. Here, for the region information of the road region, a section code assigned to each section of a road in the surrounding area map may be used, besides the region code.

The information display unit 105 controls displaying of the frequency information received from the frequency information integration unit 201, which is integrated per unit wide region or per road region, on the surrounding area map received from the map information generation unit 103.

Next, the operation of the information processing device of the second example embodiment will be described, using a drawing. Here, the operation in the second embodiment will be described only on a step different from the operation in the first example embodiment, and a description of common steps is omitted. Further, as a drawing for the present description, FIG. 3 illustrating the operation in the first example embodiment will be used. In the information processing device of the second example embodiment, between the operations for frequency information generation (S18) and information display control (S20) of the first example embodiment, an operation described below is added.

The frequency information integration unit 201 integrates pieces of frequency information of respective regions generated by the frequency information generation unit 104, per unit road region constituted by roads within a surrounding area map or per unit wide region constituted by a plurality of regions. Then, the frequency information integration unit 201 passes region information of the road region or wide region to the information display unit 105. The Information display unit 105 controls displaying of the frequency information integrated by the frequency information integration unit 201 on the surrounding area map received from the map information generation unit 103.

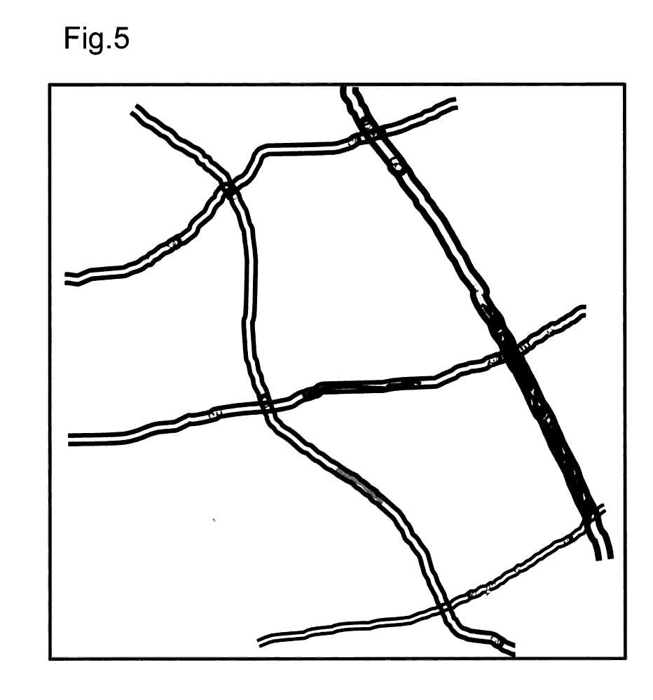

FIG. 5 is a schematic diagram illustrating a surrounding area map and frequency information of road regions displayed by the information processing device of the second example embodiment. In the example in FIG. 5, for each road in the surrounding area map, regions each expressed with a tone correlated with a value of the frequency information are displayed. In the diagram, when a large number of roads are presented in the map, displaying may be controlled such that frequency information is displayed for only desired roads. Here, the information processing device of the second example embodiment may employ either displaying a region with a tone correlated with a value of the frequency information or distinguishing the value by color, as is the case with the first example embodiment.

According to the information processing device of the second example embodiment, it is possible, in response to demand that changes unexpectedly, to present a level of the demand to the supply side, similarly to the first example embodiment. Further, by displaying the frequency information for each road region or for each wide region, the information processing device of the second example embodiment enables a taxi driver, who is a viewer of the information, to determine a route on which a passenger can be efficiently found or to obtain broad knowledge of regions where the number of passengers waiting for a taxi changes. As a result of performing a variety of ways of displaying in the information processing device, it becomes possible to analyze the change in demand from various viewpoints, and accordingly to provide information for resolving imbalance between demand and supply.

### Third Example Embodiment

The value of frequency information changes with various factors such as the elapse of time and the attribute of a person viewing the frequency information (for example, a driver).

In the first and second example embodiments, a surrounding area map to be displayed differs in the location of a taxi. However, when displaying the same region, frequency information on a region is similarly displayed regardless of whether the taxi is away or near to the region.

However, a taxi located a long way from the region on which the frequency information is displayed may be less likely to succeed in finding a passenger waiting in the region than a taxi located near to the region.

As another case, if a traffic jam occurs between the location of a taxi and a region on which the frequency information is displayed, the taxi needs a long time to arrive at that region and accordingly becomes less likely to succeed in finding a passenger waiting in the region. A third example embodiment provides an information processing device for improving such conditions.

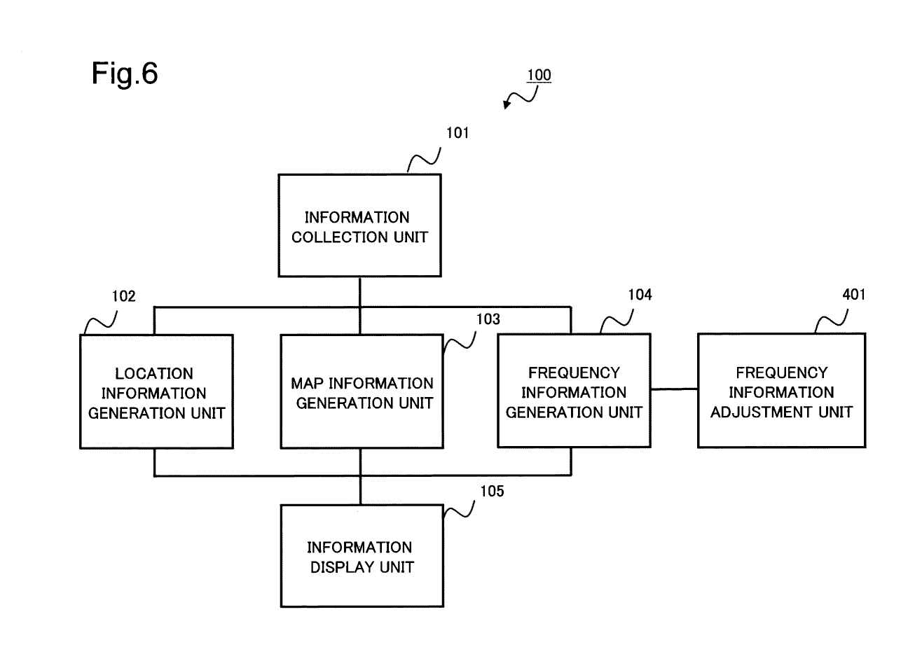

Next, the information processing device according to the third example embodiment will be described using drawings. FIG. 6 is a diagram illustrating a configuration of the information processing device according to the third example embodiment. The information processing device of the third example embodiment has a configuration obtained by adding a frequency information adjustment unit to the information processing device of the first example embodiment.

The frequency information adjustment unit 401 adjusts a value represented by frequency information, according to the distance between the location of an empty taxi and the region on which the frequency information is displayed. Specifically, the frequency information adjustment unit 401 multiplies frequency information for a region separated from the location of an empty taxi by a certain adjustment factor. For example, a value represented by frequency information for a region whose distance from the location of an empty taxi is x is multiplied by an adjustment factor exp(−x/a) (a is a coefficient). Accordingly, a value represented by frequency information decreases as the distance to that region from an empty taxi increases. Because frequency information can be thus adjusted according to the distance from that region to an empty taxi, it becomes possible to reduce the number of taxi allocations which may be in vain and accordingly to facilitate efficient taxi supply to customers.

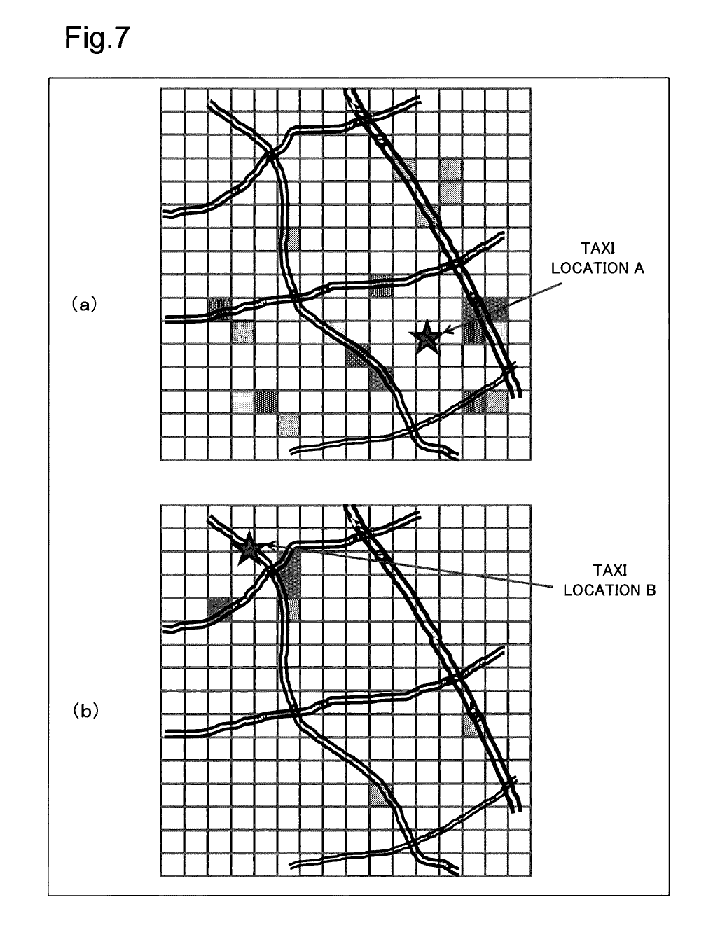

FIG. 7 is a schematic diagram illustrating a surrounding area map and frequency information displayed by the information processing device of the third example embodiment. To show that different frequency information is displayed for taxis located at different positions at the same time, in both of map (a) and map (b) in FIG. 7, instead of setting the location of a taxi as the center of a surrounding area map, locations A and B of respective taxis and frequency information at the respective the taxi locations are displayed on a fixed surrounding area map. In maps (a) and map (b), in both the taxi locations A and B, frequency information for a region more distant from the taxi location is displayed to represent a smaller value. Here, the information processing device of the third example embodiment may employ either displaying a region with a tone (mesh density) correlated with a value of the frequency information or distinguishing the value by color, similarly to the first example embodiment.

Further, the frequency information adjustment unit 401 may adjust a value represented by frequency information, according to the traffic condition of a road around the region on which the frequency information is displayed. For example, when a road to a region is crowded, the frequency information adjustment unit 401 adjusts a value of the frequency information to be smaller. Specifically, observing a vehicle speed v on a road toward the region, the frequency information is multiplied by a*v, where a is a coefficient. The vehicle speed v can be acquired from GPS information for a car or from times at which a car passes sensor positions.

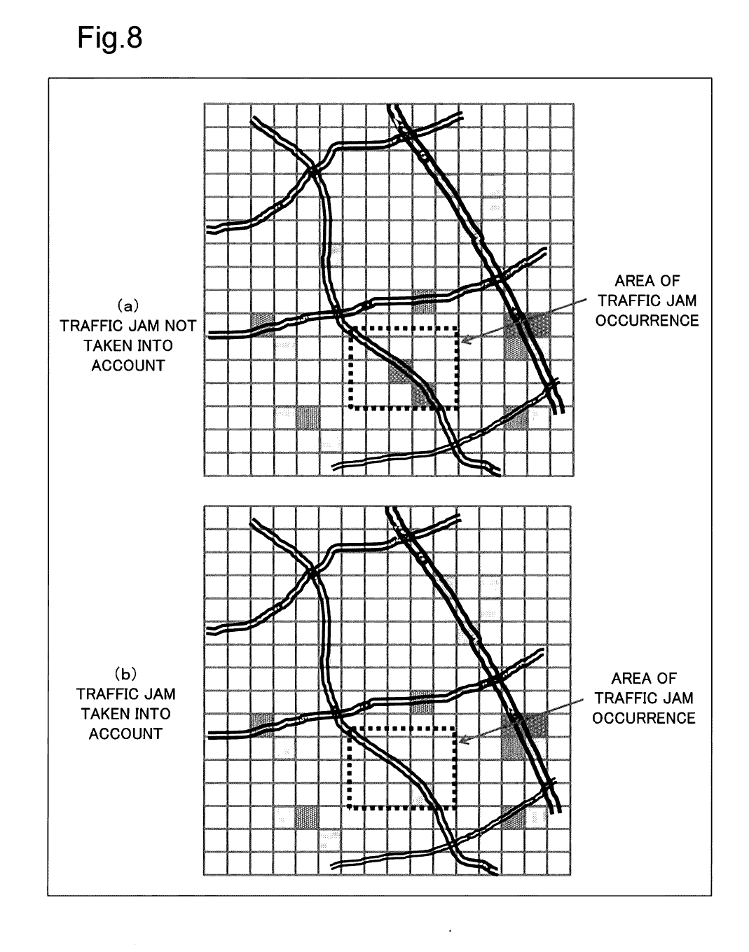

FIG. 8 is a schematic diagram illustrating a surrounding area map and frequency information adjusted by the frequency information adjustment unit, according to the third example embodiment. The third exemplary embodiment is different from the first and second example embodiments, in that frequency information is displayed to represent a smaller value as the vehicle speed becomes slower on a road around the region on which the frequency information is displayed. According to the third example embodiment, frequency information for a region along a road having a traffic jam is displayed to represent a smaller value. As a result, it becomes possible for a driver having viewed the frequency information to avoid the traffic jam and accordingly to realize efficient taxi allocation.

Here, the adjustment by the frequency information adjustment unit 401 may be performed taking into consideration not only the current traffic condition but also another condition. For example, based on information for the finishing time of a concert, the multiplication by the adjustment factor may be performed in a manner to increase a value represented by frequency information for a region around the concert venue at the finishing time of the concert.

Further, each driver of a taxi or delivery company has a specific business area. In that case, a value represented by frequency information for each region included in the area may be multiplied by an adjustment factor b (b>1). As a result, a value represented by frequency information for each region included in the specific area is increased, and accordingly is emphasized in displaying frequency information compared to regions outside the business area. It accordingly becomes possible for the driver to easily make determination on moving toward a certain area and consequently to perform the business within the area efficiently. Here, the configuration of the third example embodiment may also be applied to that of the second example embodiment.

### Fourth Example Embodiment

Next, an information processing device according to a fourth example embodiment will be described using a drawing. The information processing device according to the fourth example embodiment has a configuration obtained by adding an input unit 501 to the second example embodiment. The input unit 501 has a function to input setting information such as that on selecting a region on which frequency information is to be displayed or the like, to the frequency information integration unit 201. For example, a taxi driver sends, to the information processing device 100, desired setting information such as that on regions corresponding to the driver's business area, that on a road on which the driver plans to cruise for finding a passenger, and the like, via an information terminal installed in the taxi.

The inputted setting information is passed from the input unit 501 to the frequency information integration unit 201, and integrated frequency information is generated there. As the setting information, position information for each of two regions may be inputted in the form of a coordinate to the input unit 501, and the information integration unit 201 may accordingly integrate frequency information for every region along a straight line connecting the two positions. Subsequent processes such as of displaying and the like are the same as those in the second example embodiment. Therefore, the fourth example embodiment may also be applied to the configuration of the third example embodiment which includes that of the second example embodiment.

Further, it is desirable that the information terminal for sending setting information is provided with a touch panel, where the information terminal can control displaying of a surrounding area map of the current location on the touch panel and also can perform input control such that a desired road or region can be inputted via the touch panel.

### Fifth Example Embodiment

While the information processing devices of the first to fourth embodiments have been described on the assumption that they are installed outside a moving object, they may be installed in a moving object. For example, when the moving object is a taxi, they may be installed in the navigation system.

Next, an information processing device of a fifth example embodiment will be described. In the information processing device 100 of the fifth example embodiment, the information display unit 105 has a function to perform ON/OFF control of displayed information by which the surrounding area map and frequency information described in the above example embodiments are switched between displaying and not-displaying.

The information presented by the information processing device 100 according to each of the first to fourth example embodiments is, for example, that usually used in a taxi immediately after dropping off a passenger or while looking for a passenger.

Therefore, after taking on a passenger, information display by the information processing device is not necessary until dropping off the passenger. The information display unit 105 of the fifth example embodiment performs control such that the information display is suspended after taking on a passenger and started again after dropping off the passenger. Here, when switching off the information display, the information display unit 105 may switch displayed information to be car navigation information.

A timing signal for the switching of information display may be acquired from a taximeter. For example, the information display unit 105 suspends information display at a time the taxi takes on a passenger and the taximeter accordingly is accordingly is set at the “running with fare” mode, and starts the information display again at a time the taximeter is set at the “empty” mode. Further, a dedicated button may be provided in the navigation system so that the taxi driver switches information display by ON/OFF operation of the button.

### Other Example Embodiments

While the above example embodiments have been described in terms of a taxi-related example, they may also be used in any application for resolving imbalance between demand and supply. For example, they may be applied to matching between trucks of a delivery company and loads, and between parking lots and cars looking for a parking lot.

While a tablet terminal has been mentioned as an example of the information processing devices according to the above-described example embodiments, the example embodiments may be applied also to a cell-phone, a smartphone or a personal computer. Further, a dedicated terminal may be used instead of a general-purpose terminal.

The information processing devices of the first to fourth example embodiments each may be implemented as an information processing device built on a cloud computer. In that case, a surrounding area map and frequency information provided from the information processing device are displayed on an information terminal (for example, a navigation system) via a network.

Further, the information processing device may be configured to have some of its functions built on the information terminal side and the others on the cloud computer side.

By allocating limited resources efficiently to spatially distributed humans or objects in real time, it becomes possible to improve convenience and efficiency in a variety of businesses. The present invention can realize allocation which is adaptable in real time to the condition of a current situation, instead of preplanned allocation based on prediction.

### (Hardware Configuration)

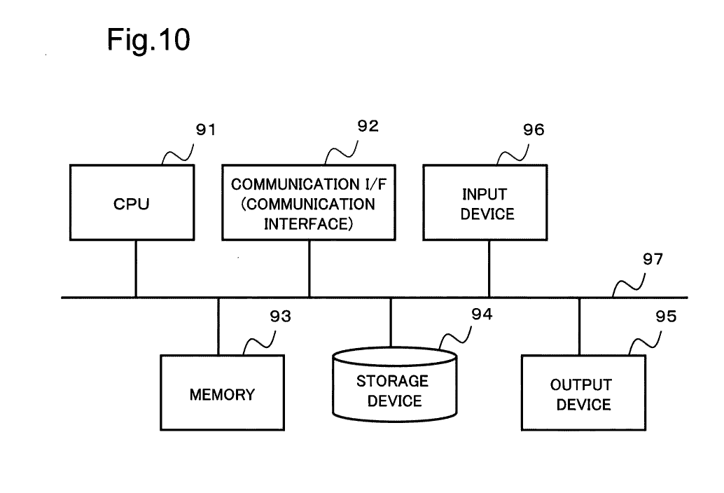

FIG. 10 is a diagram illustrating a hardware configuration with which the information processing devices in the first to fifth example embodiments of the present invention each are implemented by a computer.

As shown in FIG. 10, each of the information processing devices includes a CPU (Central Processing Unit) 91, a communication I/F (communication interface) 92 for network connection, a memory 93 and a storage device storing a program 94 such as a hard disk or the like. The CPU 91 is further connected with an input device 95 and an output device 96, via a system bus 97.

By causing its operating system to work, the CPU 91 functions as the location information generation unit, map information generation unit, frequency information generation unit, information display unit, frequency information integration unit and frequency information adjustment unit of each of the information processing devices according to the first to fifth example embodiments of the present invention. Further, for example, the CPU 91 reads a program and data from a recording medium mounted on a drive device into the memory 93.

The CPU 91 further has, for example, a function to process information inputted from the information collection unit or the like of the information processing device in each of the example embodiments, and performs processes of various functions according to the program.

The storage device 94 is, for example, an optical disk, a flexible disk, a magneto-optical disk, an external hard disk, or a semiconductor memory or the like. Some of recording media in the storage device 94 is a nonvolatile storage device, where the program is stored. Further, the program may be downloaded from an external computer, which is not illustrated here but connected via a communication network.

The input device 95 is implemented by, for example, a mouse, a keyboard, a keybutton, or a touch panel or the like, and is used for input operation.

The output device 96 is implemented by a display, for example, and is used for outputting and checking information processed by the CPU 91 or the like.

Thus, the example embodiments of the present invention each are implemented by the hardware configuration shown in FIG. 10. However, means for implementing respective ones of the units included in the information processing devices are not limited to any particular ones. That is, the information processing devices each may be implemented by a physically combined single device, or may be implemented by a plurality of devices which are physically separated from each other but connected by wire or wireless.

Thus, the present invention has been described above taking the example embodiments as typical examples. However, the present invention is not limited to the above-described example embodiments. That is, to the present invention, various aspects which can be understood by those skilled in the art may be applied within the scope of the present invention.

Part or the whole of the above-described example embodiments can be described as, but are not limited to, the following supplementary notes.

(Supplementary Note 1)

An information processing device according to one aspect of the present invention includes:
an information collection unit that collects first position information representing a position of a first moving object and second position information representing a position at which a second moving object takes on a transport target;
a location information generation unit that generates location information of the first moving object, based on the first position information;
a map information generation unit that generates a surrounding area map of the first moving object, based on the location information;
a frequency information generation unit that, based on the surrounding area map and the second position information, generates frequency information representing the number of times that the second moving object takes on the transport target per unit time in any region of the surrounding area map; and
an information display unit controls displaying of the surrounding area map and the frequency information.

(Supplementary Note 2)

The information processing device according to supplementary note 1, further includes:
a frequency information integration unit that integrates pieces of frequency information for respective regions generated by the frequency information generation unit per unit road region including a predetermined road within a surrounding area map or per unit wide region including a plurality of the road regions, wherein
the information display unit controls displaying of the surrounding area map and the frequency information that is integrated.

(Supplementary Note 3)

The information processing device according to supplementary note 1 or 2, further includes:
a frequency information adjustment unit that adjusts a value of the frequency information, depending on distance between the location and the road region on which the frequency information is displayed.

(Supplementary Note 4)

The information processing device according to supplementary note 3, wherein the frequency information adjustment unit performs the adjustment in a manner to decrease a value represented by the frequency information with increasing the distance.

(Supplementary Note 5)

The information processing device according to supplementary note 1 or 2, further includes:
a frequency information adjustment unit that adjusts a value represented by the frequency information, depending on a traffic condition of a road around the road region on which the frequency information is displayed.

(Supplementary Note 6)

The information processing device according to supplementary note 5, wherein the frequency information adjustment unit performs the adjustment in a manner to decrease a value represented by the frequency information with decreasing the vehicle speed on the road.

(Supplementary Note 7)

The information processing device according to supplementary note 1 or 2, further includes:
a frequency information adjustment unit that adjusts a value of the frequency information, depending on an attribute of a driver of the first moving object.

(Supplementary Note 8)

The information processing device according to any one of supplementary notes 1 to 7, wherein
the information display unit performs control to display a preset color, tone or icon correlated with a value represented by the frequency information.

(Supplementary Note 9)

The information processing device according to any one of supplementary notes 1 to 8, further includes:
an input unit that inputs setting information for the road region on which the frequency information is displayed, to the frequency information generation unit.

(Supplementary Note 10)

The information processing device according to any one of supplementary notes 1 to 9, wherein the information display unit controls ON/OFF of displaying of the surrounding area map and the frequency information.

(Supplementary Note 11)

The information processing device according to any one of supplementary notes 1 to 10, wherein the information display unit controls ON/OFF of displaying of the surrounding area map and the frequency information.

(Supplementary Note 12)

The information processing device according to supplementary note 11, wherein the information display unit controls ON/OFF of displaying of the surrounding area map and the frequency information, in response to the transport target's getting on and off the moving object.

(Supplementary Note 13)

A processing method according to the present invention includes: collecting first position information representing a position of a first moving object and second position information representing a position at which a second moving object takes on a transport target;
generating location information of the first moving object, based on the first position information;
generating a surrounding area map of the first moving object, based on the location information;
based on the surrounding area map and the second position information, generating frequency information representing number of times that the second moving object takes on the transport target per unit time in any region of the surrounding area map; and controlling displaying of the surrounding area map and the frequency information.

(Supplementary Note 14)

A recording medium storing a program for causing a computer to execute:
collecting first position information representing a position of a first moving object and second position information representing a position at which a second moving object takes on a transport target;
generating location information of the first moving object, based on the first position information;
generating a surrounding area map of the first moving object, based on the location information;
based on the surrounding area map and the second position information, generating frequency information representing number of times that the second moving object takes on the transport target per unit time in any region of the surrounding area map; and
controlling displaying of the surrounding area map and the frequency information.

This application is based upon and claims the benefit of priority from Japanese Patent Application No. 2014-130,629, filed on Jun. 25, 2014, the disclosure of which is incorporated herein in its entirety by reference.

### REFERENCE SIGNS LIST

91 CPU

92 communication I/F (communication interface)

93 memory

94 storage device

95 input device

96 output device

97 system bus

101 information collection unit

102 location information generation unit

103 map information generation unit

104 frequency information generation unit

105 information display unit

201 frequency information integration unit

401 frequency information adjustment unit

501 input unit

1. An information processing device comprising:
an information collection unit that collects first position information representing a position of a first moving object and second position information representing a position at which a second moving object takes on a transport target;
a location information generation unit that generates location information of the first moving object, based on the first position information;
a map information generation unit that generates a surrounding area map of the first moving object, based on the location information;
a frequency information generation unit that, based on the surrounding area map and the second position information, generates frequency information representing the number of times that the second moving object takes on the transport target per unit time in any region of the surrounding area map; and
an information display unit that controls displaying of the surrounding area map and the frequency information.

2. The information processing device according to claim 1, further comprising:
a frequency information integration unit that integrates pieces of frequency information for respective regions generated by the frequency information generation unit per unit road region including a predetermined road within a surrounding area map or per unit wide region including a plurality of the road regions, wherein
the information display unit controls displaying of the surrounding area map and the frequency information that is integrated.

3. The information processing device according to claim 1, further comprising:
a frequency information adjustment unit that adjusts a value of the frequency information, depending on distance between the location and the road region on which the frequency information is displayed.

4. The information processing device according to claim 1, further comprising:
a frequency information adjustment unit that adjusts a value represented by the frequency information, depending on a traffic condition of a road around the road region on which the frequency information is displayed.

5. The information processing device according to claim 1, further comprising:
a frequency information adjustment unit that adjusts a value of the frequency information, depending on an attribute of a driver of the first moving object.

6. The information processing device according to claim 1, wherein
the information display unit performs control to display a preset color, tone or icon correlated with a value represented by the frequency information.

7. The information processing device according to claim 1, further comprising:
an input unit that inputs setting information for the road region on which the frequency information is displayed, to the frequency information generation unit.

8. The information processing device according to claim 1, wherein
the information display unit controls ON/OFF of displaying of the surrounding area map and the frequency information.

9. A processing method comprising:
collecting first position information representing a position of a first moving object and second position information representing a position at which a second moving object takes on a transport target;
generating location information of the first moving object, based on the first position information;
generating a surrounding area map of the first moving object, based on the location information;
based on the surrounding area map and the second position information, generating frequency information representing number of times that the second moving object takes on the transport target per unit time in any region of the surrounding area map; and
controlling displaying of the surrounding area map and the frequency information.

10. A non-transitory computer-readable recording medium storing a program for causing a computer to execute:
collecting first position information representing a position of a first moving object and second position information representing a position at which a second moving object takes on a transport target;
generating location information of the first moving object, based on the first position information;
generating a surrounding area map of the first moving object, based on the location information;
based on the surrounding area map and the second position information, generating frequency information representing number of times that the second moving object takes on the transport target per unit time in any region of the surrounding area map; and
controlling displaying of the surrounding area map and the frequency information.
